(19) United States
(12) Patent Application Publication
(10) Pub. No.: US 2009/0235531 A1
(43) Pub. Date: Sep. 24, 2009

(54) TUBE CUTTER TO PREVENT DAMAGE TO INTERNAL ELECTRICAL OR OPTICAL CABLES

(75) Inventor: Joseph Allan Nicholson, Cumbria (GB)

Correspondence Address: SCHLUMBERGER RESERVOIR COMPLETIONS, 14910 AIRLINE ROAD, ROSHARON, TX, 77583, US

(73) Assignee: SCHLUMBERGER TECHNOLOGY CORPORATION, Sugar Land, TX (US)

(21) Appl. No.: 12/054,202

(22) Filed: Mar. 24, 2008

(51) Int. Cl. B23D 21/06

(52) U.S. Cl. 30/93

(57) ABSTRACT

A tube cutter apparatus comprises a body that is generally cylindrical in shape and has a bore through which a tube to be cut is inserted. The tube cutter apparatus may further comprise a coupling restraining the tube and a bearing tube defining at least a portion of the bore. A revolving unit may be provided comprising a retaining flange. The revolving unit may further comprise a rotary tool holder including a cutting tool configured to cut the tube. An end flange, the retaining flange and the rotary tool holder may be coupled together to revolve as a unit. The tube cutting apparatus of the present invention may further include devices for setting the depth of the cut of the cutting tool and for setting the point at which the cutting operation will stop.

### BACKGROUND OF THE INVENTION

1. Field of the Invention

The present invention relates generally to apparatus for cutting the outer tube of steel conduit cables, and, more particularly, for cutting the outer tube of such conduit cables that contain electrical or optical cables.

2. Description of the Prior Art

The installation of electrical steel conduit cables on-site requires that the outer tube be cut to the required length for termination and pressure sealing. Such a tube has a relatively thin wall and cutting the tube requires a great deal of skill not to damage the electrical insulation inside the tubing. While a triangular file is often used for such cutting, the site conditions can prevent the technician gaining access to both view and perform the required 360° cut with a suitable filing action. If two cables exist in a side by side relationship, this task is doubly more difficult.

Conventional tube cutters require a lot of space and the cutting device often uses a hardened steel blade which rotates around the tube, cutting into the material by cold working and deformation of the tube wall material. This type of cutter causes a flow of material into the inside bore and can damage the cable insulation as a result of this “necking” and the sharp edge that then results when the cable is broken.

A tool would therefore be advantageous that performs a cutting action that notches the tubing without deformation to the tube bore and that it is able to be operated between at least two exiting cables in close proximity to one another. It would also be advantageous if the tool could produce a chamfer at the same time to allow seals to be fitted over the tubing without damaging the seals when fitted.

### SUMMARY OF THE INVENTION

In accordance with the present invention, tube cutter apparatus is provided comprising a body which is generally cylindrical in shape and which has a bore through the body. The tube cutter apparatus further comprises a device to prevent lateral movement of the tube to be cut during a cutting operation, and a revolving unit containing a tool for cutting the tube.

In one embodiment, tube apparatus according to the present invention includes a bearing tube which defines a portion of the bore and through which the tube that is to be cut is inserted. A coupling radially surrounds a portion of the bearing tube and is in contact with the bearing tube. The coupling comprises at least one device to secure the tube to be cut in place when the tube is inserted in the bore and thereby prevent lateral movement of the tube during the cutting operation.

In one embodiment, the revolving unit of tube cutter apparatus in accordance with the present invention comprises a retaining flange proximate the coupling wherein the retaining flange also engages a portion of the load bearing tube. In this embodiment, the revolving unit also includes a rotary tool holder which is proximate the retaining flange and which is also in contact with a portion of the bearing tube, and the rotary tool holder includes a cutting tool for cutting the tube. The revolving unit of this embodiment additionally comprises an end flange proximate the rotary tool holder, and the end flange the retaining flange and the rotary tool holder are coupled together so that they may revolve as a unit.

Tube cutter apparatus in accordance with the present invention further comprises apparatus for setting the depth of cut of the cutting tool and for setting the point at which the cutting operation stops. In one embodiment, this apparatus includes a grub screw to set the depth of cut of the cutting tool and a second grub screw to set the stop point for the cutting tool.

A tube cutter according to the present invention produces a chamfered cut on the tube. This chambered end facilitates the attachment of seals to the end of the tube that has been cut.

In one embodiment, the securing device in the coupling comprises at least one socket cap screw.

### BRIEF DESCRIPTION OF THE DRAWINGS

In the accompanying drawings:

FIG. 1 is a perspective drawing of one embodiment of a tube cutter in accordance with the present invention.

FIG. 2 is an exploded diagram of the component parts of the tube cutter illustrated in FIG. 1.

FIG. 3 is a top view of a tube which has been cut using the tube cutter apparatus of FIGS. 1 and 2.

### DESCRIPTION OF THE SPECIFIC EMBODIMENTS

It will be appreciated that the present invention may take many forms and embodiments. In the following description, some embodiments of the invention are described and numerous details are set forth to provide an understanding of the present invention. Those skilled in the art will appreciate, however, that the present invention may be practiced without those details and that numerous variations and modifications from the described embodiments may be possible. The following description is thus intended to illustrate and not to limit the present invention.

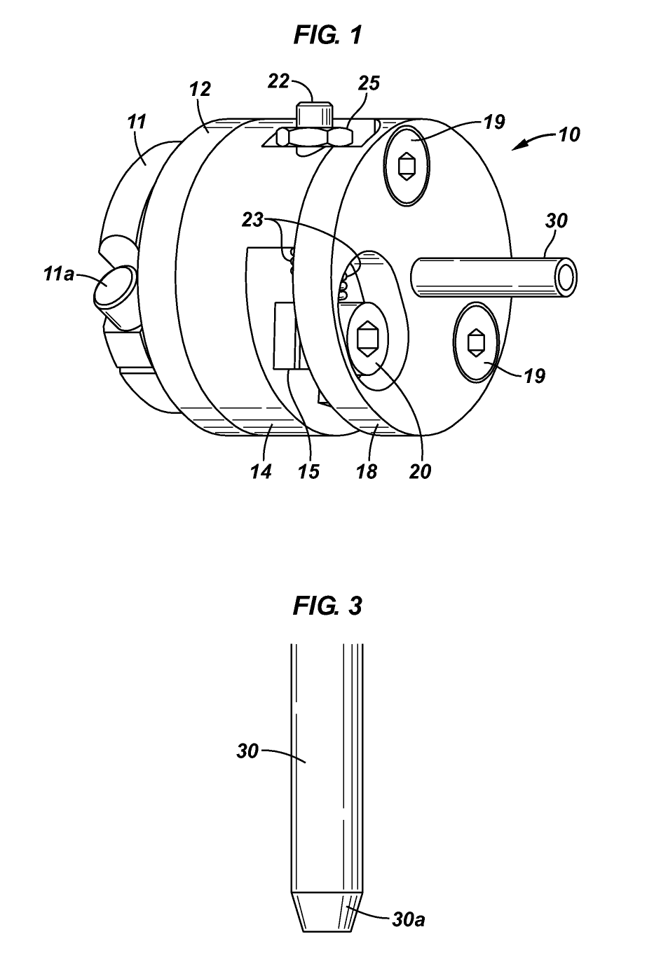

Referring first to FIG. 1, tube cutter apparatus 10 in accordance with the present invention comprises a body which is generally cylindrical in shape and which has a bore through the body through which the tube 30 to be cut is inserted.

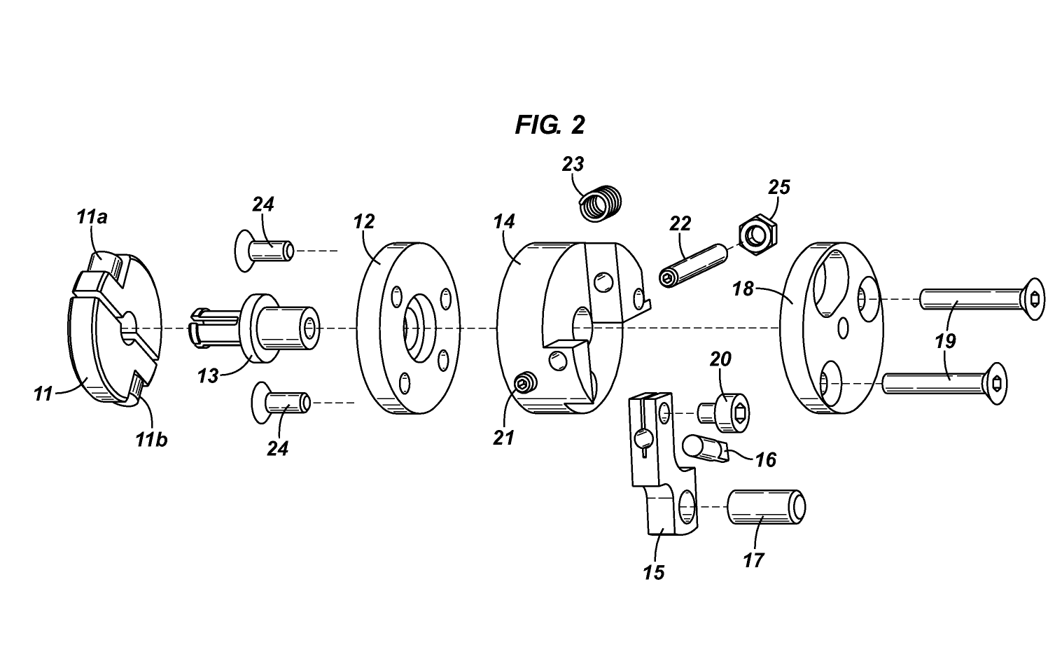

Referring to FIGS. 1 and 2, tube cutter apparatus 10 comprises a bearing tube 13 which defines a portion of the bore of the tube cutter apparatus 10, and the bearing tube 13 is located at one end of the tube cutter apparatus 10. A coupling 11 surrounds a portion of the bearing tube 13 and is in contact with a portion of the bearing tube 13. Coupling 11 comprises at least one device to secure the tube 30 to be cut in place so that no lateral movement of the tube 30 occurs during the cutting operation. In the embodiment illustrated in FIGS. 1 and 2, coupling 11 comprises two shaft half couplings 11a and 11b, which, when tightened, will prevent lateral movement of the tube during the cutting operation.

Still referring to FIGS. 1 and 2, tube cutter apparatus 10 further comprises a revolving unit which includes a retaining flange 12 which is proximate to the coupling 11 and which is also in contact with a portion of the bearing tube 13. The revolving unit further comprises a rotary tool holder 14 which is proximate the retaining flange 12 and which is also in contact with a portion of the bearing tube 13. The rotary tool holder 14 includes a cutting tool 16 which is securely coupled to radius arm 15 with screw 20. The radius arm, once assembled with cutting tool 16, may advantageously be installed in rotary tool holder 14 by using dowel 17. Cutting tool 16 may, for example, be fabricated from high speed steel (HSS).

The revolving unit of tube cutter apparatus 10 in accordance with the present invention further includes an end flange 18 which is proximate to the rotary tool holder 14. The combination of end flange 18, rotary tool holder 14 and retaining flange 12 may be coupled together by using screws 19, and screws 24 may be utilized to further couple retaining flange 12 and rotary tool unit 14 together.

The revolving unit of tube cutter apparatus 10 further comprises devices for setting the depth of cut of the cutting tool and for setting the point at which the cutting tool will stop cutting the tube. In the embodiment illustrated in FIGS. 1 and 2, these devices comprise grub screws 21 and 22. Grub screw 21 is in threaded engagement with the body of rotary tool holder 14, and one end of grub screw 21 impinges on radius arm 15 so as to set the depth of the cut by cutting tool 16. The combination of spring 23, grub screw 22 and lock nut 25 function to set the point at which the cutting operation will stop.

By utilizing tube cutter apparatus 10 in accordance with the present invention, the cutting of two tubes which are in proximity to one another is facilitated. In addition, the cutting tool 16 produces a chamfered cut 30a on tube 30 as illustrated in FIG. 3. The chamfered cuts provide good surface finishes for fitting seals at the end of the tube 30.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A tube cutter apparatus comprising a body that is generally cylindrical in shape and that has a bore through the body in which a tube to be cut is inserted, comprising:
a coupling unit configured to prevent lateral movement of the tube during the cutting operation;
a revolving unit including a cutting tool for cutting the tube; and
a setting device for setting the depth of the cut of the cutting tool.

2. The tube cutter apparatus of claim 1, wherein the setting device comprise a grub screw.

3. The tube cutter apparatus of claim 1, further comprising a second setting device for setting the point at which the cutting operation is to stop.

4. The tube cutting apparatus of claim 1, wherein the revolving unit comprises a bearing tube defining at least a portion of the bore.

5. The tube cutting apparatus of claim 1, wherein the cutting tool is configured to produce a chamfered cut.

6. A tube cutter apparatus comprising a body that is generally cylindrical in shape and that has a bore through the body, said tube cutter comprising:
a bearing tube defining at least a portion of the bore and through which a tube to be cut is inserted;
a coupling configured to radially surround and abut a portion of the bearing tube, said coupling comprising at least one securing device to retain the tube in place when the tube is inserted in the bore; and
a revolving unit which comprises:
(i) a retaining flange proximate the coupling and configured to engage a portion of the bearing tube;
(ii) a rotary tool holder that is proximate the retaining flange and configured to abut a portion of the bearing tube, said rotary tool holder including a cutting tool for cutting the tube;
(iii) an end flange proximate the rotary tool holder, said end flange, retaining flange and rotary tool holder being coupled together to revolve as a unit; and
(iv) a setting apparatus for setting the depth of the cut of the cutting tool.

7. The tube cutter apparatus of claim 6, wherein the securing device comprises at least one socket cap screw.

8. The tube cutter apparatus of claim 6, wherein said setting apparatus comprises a grub screw.

9. The tube cutter apparatus of claim 6, wherein the cutting tool produces a chamfered cut on the tube.

10. The tube cutter apparatus of claim 6, further comprising a second setting apparatus for setting the point at which the cutting operation is to stop.
